(19) United States
(12) Patent Application Publication
(10) Pub. No.: US 2023/0288977 A1
(43) Pub. Date: Sep. 14, 2023

(54) COMPUTER-READABLE RECORDING MEDIUM STORING POWER CONTROL PROGRAM, INFORMATION PROCESSING DEVICE, AND POWER CONTROL METHOD

(71) Applicant: Fujitsu Limited, Kawasaki-shi (JP)

(72) Inventor: Akira HIRAI, Kawasaki (JP)

(73) Assignee: Fujitsu Limited, Kawasaki-shi (JP)

(21) Appl. No.: 18/067,920

(22) Filed: Dec. 19, 2022

(30) Foreign Application Priority Data
Mar. 10, 2022 (JP) 2022-037524

(51) Int. Cl. G06F 1/3234; G06F 1/3296

(52) U.S. Cl. CPC G06F 1/3275; G06F 1/3296

(57) ABSTRACT

A non-transitory computer-readable recording medium stores a power control program for causing a computer to execute processing including: monitoring an integrated value of energy consumption consumed by a memory for every predetermined period counted by an interrupt counter; and performing control to increase an operating frequency and a voltage of a memory system at timing of receiving an interrupt that occurs in a case where the interrupt counter overflows on a basis of an upper limit threshold of power consumption per predetermined period set in advance in the interrupt counter.

### CROSS-REFERENCE TO RELATED APPLICATION

This application is based upon and claims the benefit of priority of the prior Japanese Patent Application No. 2022-37524, filed on Mar. 10, 2022, the entire contents of which are incorporated herein by reference.

### FIELD

The embodiment discussed herein is related to a power control program and the like.

### BACKGROUND

In recent years, the amount of memory installed in a computer system has increased, and power consumption in a main body of the memory and a memory system in a controller for controlling a memory has come to occupy a large proportion. Therefore, controlling power consumed by the memory system is very important to improve power efficiency of the computer system.

U.S. Patent Application Publication No. 2020/0183597, U.S. Patent Application Publication No. 2011/0320839, and Japanese National Publication of International Patent Application No. 2017-526039 are disclosed as related art.

### SUMMARY

According to an aspect of the embodiments, a non-transitory computer-readable recording medium stores a power control program for causing a computer to execute processing including: monitoring an integrated value of energy consumption consumed by a memory for every predetermined period counted by an interrupt counter; and performing control to increase an operating frequency and a voltage of a memory system at timing of receiving an interrupt that occurs in a case where the interrupt counter overflows on a basis of an upper limit threshold of power consumption per predetermined period set in advance in the interrupt counter.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a hardware configuration of an information processing device according to an embodiment;

FIG. 2 is a table illustrating an example of a power control management table according to the embodiment;

FIG. 3 is a diagram illustrating an example of state value information;

FIG. 4 is a diagram for describing processing using a counter according to the embodiment;

FIG. 5A is a diagram (1) illustrating an example of a flowchart of power control according to the embodiment;

FIG. 5B is a diagram (2) illustrating an example of a flowchart of the power control according to the embodiment; and

FIG. 6 is a reference diagram for describing a case where memory access performance is not able to be secured.

### DESCRIPTION OF EMBODIMENTS

A computer system of recent years has a mechanism for changing a frequency and a voltage for each control unit (a set of a controller and a memory) of a memory system. Such a mechanism can reduce the power consumption by setting a low frequency and a low voltage. However, when the power consumption is reduced, a delay may occur during memory access, so appropriate control is required. For example, a mechanism for changing the frequency and voltage according to a load of the memory system is required.

Here, techniques for controlling the number of memory channels to be used and the frequency and voltage of a memory system on the basis of memory access characteristics of a program to be executed have been disclosed.

Furthermore, a method of determining a load of a memory system from the power consumption of a memory is known. In such a method, the power consumption of the memory is read at regular intervals by a measuring device or the like, the load of the memory is determined from the read power consumption of the memory, and the frequency and voltage are controlled according to the load of the memory.

However, the method of determining the load of the memory system based on the power consumption of the memory has a problem that memory access performance may not be able to be secured. For example, the conventional method may not be able to cope with changes in the power consumption within the read interval and may not be able to secure the memory access performance due to occurrence of delays in power control.

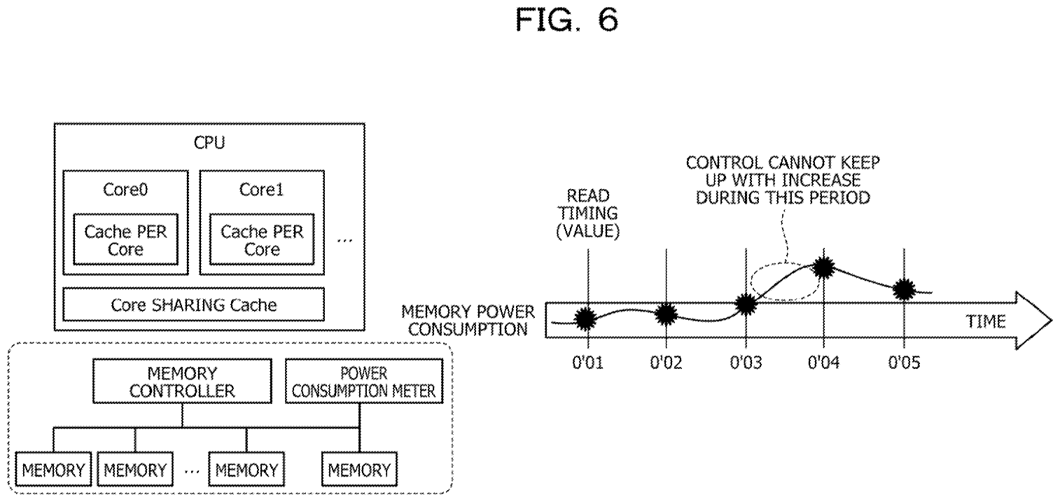

Here, a case where the memory access performance is not able to be secured will be described with reference to FIG. 6. FIG. 6 is a reference diagram for describing a case where the memory access performance is not able to be secured. An example of a computer system including a memory system is illustrated on the left of FIG. 6. The memory system includes a memory controller and memories. Then, the memory controller is equipped with a power consumption meter that represents a device that measures the power consumption.

In such a memory system, when the power consumption meter reads the power consumption of the memory at regular intervals, the power control may not be able to cope with changes in the power consumption within the read interval. The interval between 0′03 and 0′04 illustrated on the right of FIG. 6 is the case where the power control is not able to cope with a change in the power consumption of the memory within the read interval. Since the power control is executed at read timing, in such a case, the power control cannot keep up with an increase in the power consumption of the memory, and the memory access performance is not able to be secured.

In one aspect, an object of the present embodiment is to control memory power so as to secure memory access performance.

Hereinafter, an embodiment of a power control program, an information processing device, and a power control method disclosed in the present application will be described in detail with reference to the drawings. Note that the present embodiment is not limited to the embodiment.

### Embodiment

[Hardware Configuration of Information Processing Device]

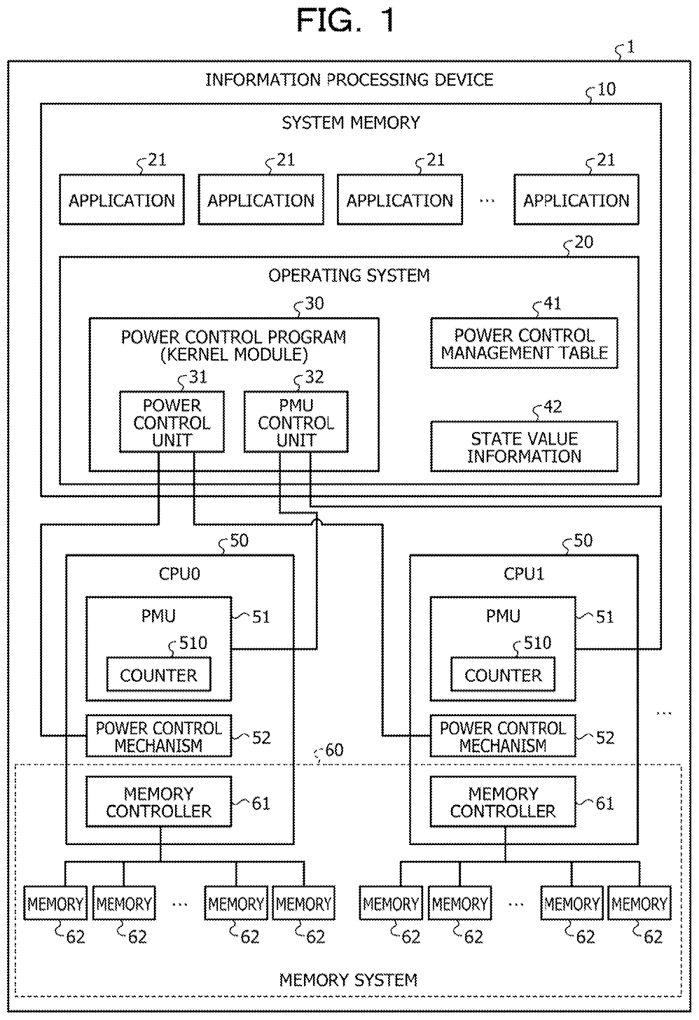

FIG. 1 is a diagram illustrating an example of a hardware configuration of an information processing device according to an embodiment. As illustrated in FIG. 1, an information processing device 1 has a central processing unit (CPU) 50, a system memory 10, and a memory 62.

The CPU 50 is connected with the system memory 10 and the memory 62 via a bus. The CPU 50 includes a performance monitoring unit (PMU) 51 and a power control mechanism 52, and has a memory controller 61 built therein. The memory controller 61 is a controller that controls the memory 62. Note that the information processing device 1 illustrated in FIG. 1 includes two CPUs 50 but the information processing device 1 may include three CPUs 50 or one CPU 50.

The PMU 51 is a performance monitoring mechanism, and uses a counter 510 to monitor performance of the memory 62. For example, the PMU 51 accumulates electrical energy (power amount) consumed by the memory 62 by counting up the counter 510 for a fixed period (for example, in units of clock frequency). Then, a PMU control unit 32 reads and monitors the counter 510 in every fixed period (for example, 1 second). Note that the PMU 51 has a plurality of counters 510, but one free counter 510 is used.

The power control mechanism 52 has a control function capable of changing an operating frequency and a voltage of a control unit (a combination of the memory controller 61 and the memory 62) of a memory system 60, which will be described below, at arbitrary timing.

The memory controller 61 built in the CPU 50 and the memory 62 connected to the memory controller 61 are the control unit of the memory system 60. In the embodiment, a load of this memory system 60 is determined by energy consumption of the memory 62. Then, the energy consumption of the memory 62 is considered as performance, and the counter 510 is used to monitor an integrated value of the energy consumption. The counter 510 is set with the integrated value of the energy consumption of the memory 62 as a counter event. An interrupt is then generated when the counter 510 overflows.

The system memory 10 has an operating system 20 and an application 21. The operating system 20 includes a power control program 30, a power control management table 41, and state value information 42.

The power control program 30 is one of kernel modules. The power control program 30 monitors the integrated value of the energy consumption of the memory 62 counted by the counter 510 in every fixed period. The fixed period is, for example, one second but is not limited thereto. Then, the power control program 30 performs control to increase the operating frequency and voltage of the memory system 60 at timing of receiving an interrupt that occurs in a case where the counter 510 exceeds a preset upper limit threshold (overflows).

The power control management table 41 is a table used for managing a threshold used for control according to the power consumption of the memory 62. In the power control management table 41, the threshold of the power consumption for changing the operating frequency and voltage of the memory system 60 according to the power consumption is set. Note that the power control management table 41 is prepared in the system memory 10 in advance.

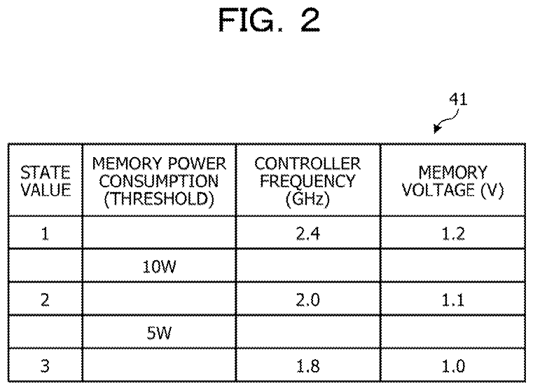

Here, an example of the power control management table 41 will be described with reference to FIG. 2. FIG. 2 is a table illustrating an example of the power control management table according to the embodiment. As illustrated in FIG. 2, the power control management table 41 stores a state value, memory power consumption (threshold), a controller frequency (GHz), and a memory voltage (V) in association with one another. The state value is a value indicating a state associated with the operating frequency and voltage set in the memory system 60. The memory power consumption (threshold) is a threshold of the power consumption of the memory set according to a level of the operating frequency and voltage. The memory power consumption (threshold) has an upper limit threshold, a lower limit threshold, or an upper limit threshold and a lower limit threshold, according to the level of the operating frequency and voltage. The controller frequency (GHz) is information indicating the operating frequency set in the memory controller 61 of the memory system 60. The memory voltage (V) is information indicating the voltage set in the memory 62 of the memory system 60.

As an example, in a case where the state value is “2”, “10 W” is stored as the upper limit threshold and “5 W” as the lower limit threshold for the memory power consumption (threshold). In addition, “2.0” is stored as the controller frequency (GHz). “1.1” is stored as the memory voltage (V). For example, the example means that, in the case where the state value is “2”, the controller frequency is set to “2.4” GHz and the memory voltage is set to “1.2” V in a case where the memory power consumption exceeds “10 W”. In addition, the example means that, in the case where the state value is “2”, the controller frequency is set to “1.8” GHz and the memory voltage is set to “1.0” V in a case where the memory power consumption falls below “5 W”.

The state value information 42 is information indicating the current state value of the memory system 60. Note that the state value information 42 is set and updated by the PMU control unit 32, which will be described below.

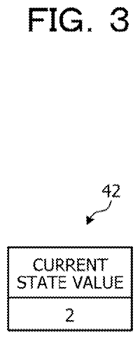

Here, an example of the state value information 42 will be described with reference to FIG. 3. FIG. 3 is a diagram illustrating an example of the state value information 42. As illustrated in FIG. 3, the state value information 42 stores the current state value. The current state value is information indicating a state value at the moment. The current state value corresponds to the state value of the power control management table 41. As an example, the current state value is set to “2”.

Returning to FIG. 1, the power control program 30 has a power control unit 31 and the PMU control unit 32.

The power control unit 31 controls the memory system 60. For example, the power control unit 31 instructs the power control mechanism 52 to set information indicating the operating frequency in the memory controller 61 and set information indicating the voltage of the memory 62 according to the current state value of the state value information 42. The information indicating the operating frequency and the information indicating the voltage corresponding to the current state value may be obtained from the power control management table 41.

The PMU control unit 32 controls the PMU 51.

For example, the PMU control unit 32 sets a counter event for counting the integrated value of the power consumption (energy consumption) of the memory 62 in one counter 510 out of the plurality of counters 510 in the PMU 51. In addition, the PMU control unit 32 sets an initial value of a counter value so that an interrupt occurs when the counter value overflows. As an example, in a case where there is the upper limit threshold value according to the current state value of the state value information 42, the PMU control unit 32 sets the count value at a value obtained by converting the upper limit threshold into energy as an initial value so that the count value of the counter 510 overflows when the count value exceeds the upper limit threshold. In a case where there is no upper limit threshold according to the current state value, the PMU control unit 32 may set the counter value of the counter 510 to “0” so that an interrupt occurs when the counter value overflows. For example, in the case where there is the upper limit threshold according to the current state value, the value (CounterValue) set as the counter value of the counter 510 is calculated as shown in Expression (1). Note that CounterMax indicates a maximum value that the counter value of the counter 510 can represent. EnergyThreshold indicates a value obtained by converting the upper limit threshold into energy.

CounterValue=CounterMax−EnergyThreshold+1 Expression (1)

Therefore, the PMU 51 communicates with the memory system 60, accumulates the energy consumption of the memory 62 in every fixed period, and sets the counter value at the accumulated value. Then, the PMU 51 generates an interrupt when the counter value overflows. The fixed period is, for example, the clock frequency, but is not limited thereto.

Furthermore, the PMU control unit 32 monitors the counter 510 of the PMU 51. For example, the PMU control unit 32 reads the counter value of the counter 510 in every fixed period. In a case where the read counter value is equal to or less than a value obtained by converting a lower threshold corresponding to the current state value of the state value information 42 into energy, the PMU control unit 32 changes the current state value into a direction of decreasing the threshold so as to cause the power control unit 31 to perform control to decrease the operating frequency and voltage of the memory system 60. Therefore, the PMU control unit 32 can suppress power consumption. Furthermore, in the case where an interrupt occurs, the PMU control unit 32 changes the current state value into a direction of increasing the threshold so as to cause the power control unit 31 to perform control to increase the operating frequency and voltage of the memory system 60. Therefore, the PMU control unit 32 can suppress deterioration in memory access performance. For example, the PMU control unit 32 can control the memory system 60 so as to secure the memory access performance.

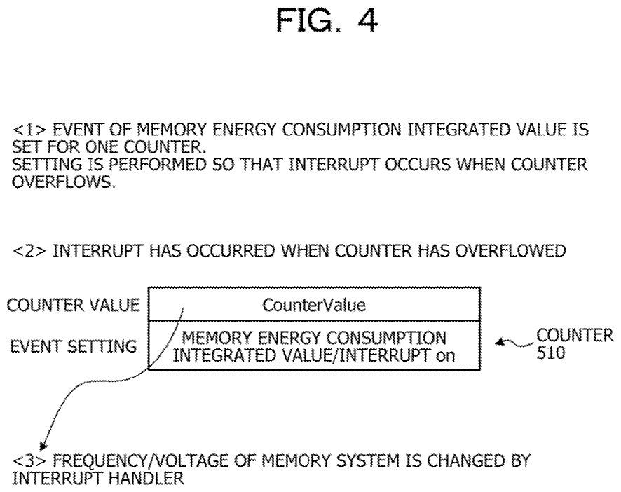

Here, processing using the counter 510 of the PMU 51 will be described with reference to FIG. 4. FIG. 4 is a diagram for describing processing using the counter according to the embodiment. As illustrated in FIG. 4, the counter 510 of the PMU 51 is illustrated. The counter 510 has a CounterValue area in which the counter value is set and an event setting area in which the counter event is set.

The PMU control unit 32 sets the counter event for counting the integrated value of the energy consumption of the memory 62 in one counter 510 out of the plurality of counters 510. Then, the PMU control unit 32 sets the initial value of the counter value to CounterValue so that an interrupt occurs when the counter value overflows (<1>).

Here, “memory energy consumption integrated value” and “interrupt on” are set in the event setting area of the counter 510. The “memory energy consumption integrated value” means an event for counting the integrated value of the power consumption (energy consumption) of the memory 62. The “interrupt on” means that an interrupt is generated when the counter value overflows.

In the case where there is the upper limit threshold according to the current state value, a value obtained by subtracting a value obtained by converting the power consumption of the upper limit threshold into energy from the maximum value that the counter value can represent and adding 1 to the subtracted value is set as the initial value of the counter value of the counter 510. For example, in a case where there is the upper limit threshold according to the current state value, the value (CounterValue) set as the counter value of the counter 510 is calculated as shown in Expression (1). For example, it is assumed that the counter value area is 32 bits, the maximum value that the counter value can represent is 0xffffffff in hexadecimal (4,294,967,295 in decimal). The energy of the memory power consumption measured by the counter 510 is 1 μJ (microjoule) per count. In the case where the upper limit threshold is 10 W, the value obtained by converting the power consumption of 10 W into energy is 10,000,000 μJ (0x00989680 in hexadecimal) indicating 10 Ws (watt seconds). Therefore, CounterValue as the initial value of the counter value is calculated as follows on the basis of Expression (1). CounterValue=0xffffffff−0x00989680+1=0xff676980 (=4,284,967,296 in decimal)

Note that in the case where there is no upper limit threshold according to the current state value, the initial value of the counter value of counter 510 is set to “0”.

The PMU 51 generates an interrupt when the counter value of the counter 510 has overflowed (<2>).

When an interrupt occurs, the PMU control unit 32 changes the operating frequency and voltage of the memory system 60 (<3>). For example, in the case where an interrupt occurs, the PMU control unit 32 changes the current state value of the state value information 42 into the direction of increasing the threshold so as to cause the power control unit 31 to perform control to increase the operating frequency and voltage of the memory system 60. Then, the power control unit 31 instructs the power control mechanism 52 to set the information indicating the operating frequency in the memory controller 61 and set the information indicating the voltage of the memory 62 according to the current state value of the state value information 42. The power control mechanism 52 then sets the information indicating the operating frequency in the memory controller 61 and sets the information indicating the voltage of the memory 62 according to the instruction from the power control unit 31.

Here, it is assumed that an interrupt has occurred when the value obtained by converting the power consumption of the upper limit threshold “10 W” into energy has overflowed. Then, the PMU control unit 32 changes the current state value of the state value information 42 from “2” to “1”. Then, the power control unit 31 instructs the power control mechanism 52 to set the operating frequency “2.4” (GHz) in the memory controller 61 and set the voltage “1.2” (V) to the memory 62 according to the current state value “1” of the state value information 42. The power control mechanism 52 sets the operating frequency “2.4” (GHz) in the memory controller 61 and set the voltage “1.2” (V) to the memory 62 according to the instruction of the power control unit 31. Therefore, the PMU control unit 32 can suppress deterioration in memory access performance. For example, the PMU control unit 32 can control the memory system 60 so as to secure the memory access performance.

In addition, the PMU control unit 32 reads the counter value of the counter 510 every second. Then, in the case where the read counter value is equal to or less than the value obtained by converting a lower threshold corresponding to the current state value of the state value information 42 into energy, the PMU control unit 32 changes the current state value into the direction of decreasing the threshold so as to cause the power control unit 31 to perform control to decrease the operating frequency and voltage of the memory system 60. Then, the power control unit 31 instructs the power control mechanism 52 to set the information indicating the operating frequency in the memory controller 61 and set the information indicating the voltage of the memory 62 according to the current state value of the state value information 42. The power control mechanism 52 then sets the information indicating the operating frequency in the memory controller 61 and sets the information indicating the voltage of the memory 62 according to the instruction from the power control unit 31.

Here, in the PMU control unit 32, the counter value read every second is assumed to be equal to or less than the value obtained by converting the lower limit threshold “5 W” into energy. Then, the PMU control unit 32 changes the current state value of the state value information 42 from “2” to “3”. Then, the power control unit 31 instructs the power control mechanism 52 to set the operating frequency “1.8” (GHz) in the memory controller 61 and set the voltage “1.0” (V) to the memory 62 according to the current state value “3” of the state value information 42. The power control mechanism 52 sets the operating frequency “1.8” (GHz) in the memory controller 61 and set the voltage “1.0” (V) to the memory 62 according to the instruction of the power control unit 31. Therefore, the PMU control unit 32 can suppress power consumption.

[Flowchart of Power Control]

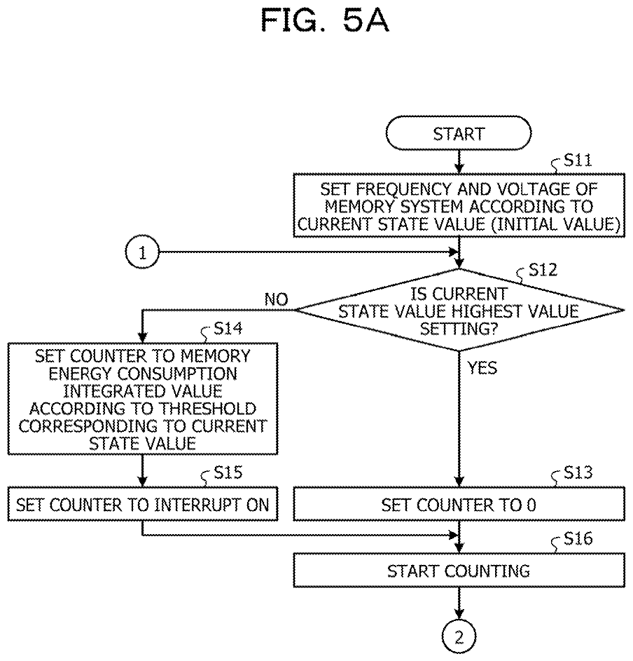

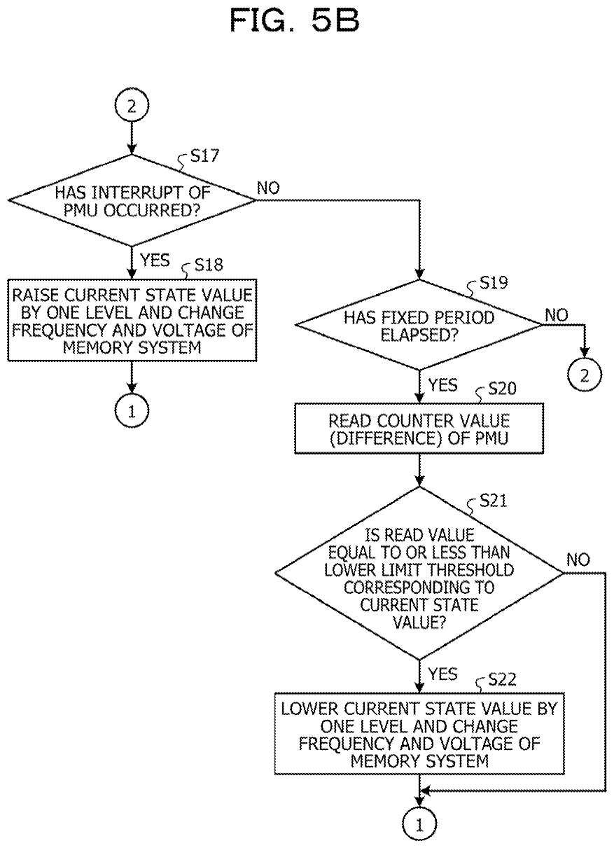

Here, an example of a flowchart of the power control according to the embodiment will now be described with reference to FIGS. 5A and 5B. FIGS. 5A and 5B are diagrams illustrating an example of flowcharts of the power control according to the embodiment.

As illustrated in FIG. 5A, the power control unit 31 sets the frequency and voltage of the memory system 60 according to the current state value (initial value) of the state value information 42 (step S11). For example, the power control unit 31 refers to the power control management table 41 and acquires controller frequency information and memory voltage information corresponding to the current state value of the state value information 42. Then, the power control unit 31 instructs the power control mechanism 52 to set the information indicating the controller frequency in the memory controller 61 and set the information indicating the memory voltage in the memory 62. Then, the power control mechanism 52 sets the information indicating the controller frequency in the memory controller 61 and sets the information indicating the memory voltage in the memory 62 according to the instruction of the power control unit 31.

The PMU control unit 32 determines whether the current state value of the state value information 42 is set to a highest value (step S12). In a case of determining that the current state value of the state value information 42 is set to the highest value (step S12; Yes), the PMU control unit 32 sets the counter value of the counter 510 to “0” (step S13). This is because the threshold according to the current state value does not have the upper limit threshold. An example is the case where the current state value of the state value information 42 is set to the state value “1” of the power control management table 41 illustrated in FIG. 2.

On the other hand, in a case of determining that the current state value of the state value information 42 is not set to the highest value (step S12; No), the PMU control unit 32 sets the counter value of the counter 510 to the memory energy consumption integrated value according to the threshold corresponding to the current state value of the state value information 42 (step S14). For example, the PMU control unit 32 acquires the upper limit threshold corresponding to the current state value of the state value information 42 from the power control management table 41. The PMU control unit 32 sets the count value of the counter 510 to the value obtained by converting the upper limit threshold into energy as the initial value.

In addition, the PMU control unit 32 sets the interrupt ON to the counter 510 (step S15). For example, the PMU control unit 32 sets the “memory energy consumption integrated value” and “interrupt on” in the event setting area of the counter 510.

Then, the PMU control unit 32 starts counting with the counter 510 (step S16).

As illustrated in FIG. 5B, the PMU control unit 32 determines whether an interrupt has occurred from the PMU 51 (step S17). In a case where it is determined that an interrupt has occurred from the PMU 51 (step S17; Yes), the PMU control unit 32 raises the current state value of the state value information 42 by one level, and changes the frequency and voltage of the memory system 60 (step S18). For example, the PMU control unit 32 raises the current state value of the state value information 42 by one level. Then, the power control unit 31 refers to the power control management table 41 and acquires the controller frequency information and the memory voltage information corresponding to the current state value of the state value information 42. Then, the power control unit 31 instructs the power control mechanism 52 to set the information indicating the controller frequency in the memory controller 61 and set the information indicating the memory voltage in the memory 62. Then, the power control mechanism 52 sets the information indicating the controller frequency in the memory controller 61 and sets the information indicating the memory voltage in the memory 62 according to the instruction of the power control unit 31. Then, the PMU control unit 32 proceeds to step S12 to initialize the counter value of the counter 510.

On the other hand, in a case where it is determined that an interrupt has not occurred from the PMU 51 (step S17; No), the PMU control unit 32 determines whether the fixed period has elapsed since the read of the counter value (step S19). In a case where it is determined that the fixed period has not elapsed (step S19; No), the PMU control unit 32 proceeds to step S17 to wait for the fixed period.

On the other hand, in a case where it is determined that the fixed period has elapsed (step S19; Yes), the PMU control unit 32 reads the counter value of the PMU 51 (step S20). For example, the PMU control unit 32 reads the energy consumption of the memory 62 for a fixed period from the counter value of the counter 510 in the PMU 51. Then, the PMU control unit 32 determines whether the read value is equal to or less than the lower limit threshold corresponding to the current state value (step S21).

In a case where it is determined that the read value is not equal to or less than the lower limit threshold corresponding to the current state value (step S21; No), the PMU control unit 32 proceeds to step S12 to initialize the counter value of the counter 510.

On the other hand, in a case where it is determined that the read value is equal to or less than the lower limit threshold corresponding to the current state value (step S21; Yes), the PMU control unit 32 lowers the current state value of the state value information 42 by one level, and changes the frequency and voltage of the memory system 60 (step S22). For example, the PMU control unit 32 lowers the current state value of the state value information 42 by one level. Then, the power control unit 31 refers to the power control management table 41 and acquires the controller frequency information and the memory voltage information corresponding to the current state value of the state value information 42. Then, the power control unit 31 instructs the power control mechanism 52 to set the information indicating the controller frequency in the memory controller 61 and set the information indicating the memory voltage in the memory 62. Then, the power control mechanism 52 sets the information indicating the controller frequency in the memory controller 61 and sets the information indicating the memory voltage in the memory 62 according to the instruction of the power control unit 31. Then, the PMU control unit 32 proceeds to step S12 to initialize the counter value of the counter 510.

[Effects of Embodiment]

In the above-described embodiment, the information processing device 1 monitors the integrated value of the energy consumption consumed by the memory 62 in every predetermined period counted by the counter 510. The information processing device 1 performs the control to increase the operating frequency and voltage of the memory system 60 at the timing of receiving the interrupt that occurs in the case where the counter 510 overflows on the basis of the upper limit threshold of the power consumption per predetermined period preset in the counter 510. According to such a configuration, the information processing device 1 can control the memory power so as to secure the memory access performance by detecting a change in the power consumption using the interrupt.

Furthermore, in the above-described embodiment, the information processing device 1 reads the integrated value of the energy consumption from the counter 510 in every fixed period. Then, the information processing device 1 performs the control to decrease the operating frequency and voltage of the memory system 60 in the case where the read integrated value of the energy consumption is equal to or less than the lower limit threshold of the power consumption per preset predetermined period. According to such a configuration, the information processing device 1 can suppress consumption of the power by using the lower limit threshold for power control.

Furthermore, in the above-described embodiment, the information processing device 1 performs the control to change the operating frequency and the voltage of the memory system 60 on the basis of the power control management table 41 that manages the threshold for performing control according to the power consumption of the memory. According to such a configuration, the information processing device 1 can perform flexible power control such as performance-oriented power control and power consumption-oriented power control by managing multi-level thresholds.

Furthermore, in the above-described embodiment, the information processing device 1 sets, for the counter 510, when having changed the operating frequency and voltage of the memory system 60, a value obtained by subtracting a value obtained by converting the power consumption indicating the upper limit threshold according to the change into energy from the maximum value that the counter 510 can represent and adding 1 to the subtracted value. According to such a configuration, the information processing device 1 can generate the interrupt according to the threshold even if the multi-level thresholds are provided, and can perform flexible power control.

[Others]

In the embodiment, the description has been given such that the power control program 30 is provided in the operating system 20, and the power control program 30 performs the power control using the counter 510. However, the power control program 30 is not limited to within the operating system 20 and may be executed by the application 21 outside the operating system 20.

Furthermore, in the power control management table 41 of the embodiment, the case where the state values are at three levels has been described. However, the state values are not limited to three levels, and may be four levels or two levels. Therefore, the information processing device 1 can perform flexible power control such as performance-oriented power control and power consumption-oriented power control by enabling the multi-level state value management.

Furthermore, each configuration element of the power control program 30 included in the information processing device 1 is not necessarily physically configured as illustrated in the drawings. For example, specific aspects of separation and integration of the respective devices are not limited to those illustrated, and all or a part thereof may be functionally or physically separated and integrated in any unit depending on various loads, use states, or the like. For example, the power control unit 31 and the PMU control unit 32 may be integrated as one unit. Furthermore, the PMU control unit 32 may be divided into a setting unit that sets a necessary value for the counter 510 of the PMU 51 and a monitoring unit that monitors the counter 510 of the PMU 51. A storage unit (not illustrated) that stores the power control management table 41, the state value information 42, and the like may be connected as an external device of the information processing device 1 via a network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a power control program for causing a computer to execute processing comprising:
monitoring an integrated value of energy consumption consumed by a memory for every predetermined period counted by an interrupt counter; and
performing control to increase an operating frequency and a voltage of a memory system at timing of receiving an interrupt that occurs in a case where the interrupt counter overflows on a basis of an upper limit threshold of power consumption per predetermined period set in advance in the interrupt counter.

2. The non-transitory computer-readable recording medium according to claim 1, further comprising:
reading the integrated value of the energy consumption from the interrupt counter in every fixed period; and
performing control to decrease the operating frequency and the voltage of the memory system in a case where the read integrated value of the energy consumption is equal to or less than a lower limit threshold of the power consumption per predetermined period set in advance.

3. The non-transitory computer-readable recording medium according to claim 2, wherein
the processing of performing control includes performing control to change the operating frequency and the voltage of the memory system on a basis of a management table that manages a threshold for performing control according to power consumption of the memory.

4. The non-transitory computer-readable recording medium according to claim 1, wherein
the processing of performing control includes, when having changed the operating frequency and the voltage of the memory system, setting, for the interrupt counter, a value obtained by subtracting a value obtained by converting the power consumption that indicates the upper limit threshold according to the change into energy from a maximum value that the interrupt counter is able to represent and adding 1 to a subtracted value.

5. A power control method comprising:
monitoring an integrated value of energy consumption consumed by a memory for every predetermined period counted by an interrupt counter; and
performing control to increase an operating frequency and a voltage of a memory system at timing of receiving an interrupt that occurs in a case where the interrupt counter overflows on a basis of an upper limit threshold of power consumption per predetermined period set in advance in the interrupt counter.

6. An information processing device comprising:
a memory; and
a processor coupled to the memory and configured to:
monitor an integrated value of energy consumption consumed by a memory for every predetermined period counted by an interrupt counter; and
perform control to increase an operating frequency and a voltage of a memory system at timing of receiving an interrupt that occurs in a case where the interrupt counter overflows on a basis of an upper limit threshold of power consumption per predetermined period set in advance in the interrupt counter.
